(19) United States
(12) Patent Application Publication
(10) Pub. No.: US 2026/0142728 A1
(43) Pub. Date: May 21, 2026

(54) RAMAN GAIN ADAPTIVE CONTROL METHOD AND SYSTEM FOR MULTI-BAND OPTICAL NETWORK

(71) Applicant: BEIJING UNIVERSITY OF POSTS AND TELECOMMUNICATIONS, Beijing (CN)

(72) Inventors: Rentao GU, Beijing (CN); Xiaoxuan GAO, Beijing (CN); Sihan LIU, Beijing (CN); Yuefeng JI, Beijing (CN)

(73) Assignee: BEIJING UNIVERSITY OF POSTS AND TELECOMMUNICATIONS, Beijing (CN)

(21) Appl. No.: 19/393,461

(22) Filed: Nov. 18, 2025

(30) Foreign Application Priority Data
Nov. 21, 2024 (CN) 202411677460.8
Nov. 21, 2024 (CN) 202411678930.2

(51) Int. Cl. H04B 10/564; H04B 10/27

(52) U.S. Cl. CPC H04B 10/564; H04B 10/27

(57) ABSTRACT

The present disclosure provides a Raman gain adaptive control method and system for multi-band optical network. The method includes: supplementing gain values of non-target channels, constructing a gain vector based on a target gain values of target channels and the supplemented gain values of the non-target channels, and performing at least one iteration; in each iteration, inputting values in a population into a pre-trained inverse model, and outputting a corresponding pump adjustment parameter; determining gain values of all channels based on the pump adjustment parameter, screening out gain values of the target channels from the gain values of all the channels, and calculating fitness based on the target gain values of the target channel and the screened gain values of the target channel; and adjusting the supplemented gain values of the non-target channels based on the objective function value, reconstructing the gain vector, performing a next iteration, and screening a final pump adjustment parameter from all the pump adjustment parameters after the last iteration is completed.

### CROSS-REFERENCE TO RELATED APPLICATIONS

This application claims priority to Chinese Patent Application No. CN202411677460.8, filed on Nov. 21, 2024, and Chinese Patent Application No. CN202411678930.2, filed on Nov. 21, 2024, which are hereby incorporated by reference in their entirety.

### TECHNICAL FIELD

The present disclosure relates to the field of optical amplifier technologies, and in particular, to a Raman gain adaptive control method and system for multi-band optical network.

### BACKGROUND

With a development of 5G/6G mobile communication and other new technologies and a continuous evolution of next-generation applications, high-capacity access traffic, such as machine-to-machine communication, continues to increase, data traffic of a transmission network rapidly increases, and as a basic transmission facility, an optical network faces a huge traffic demand, and a capacity thereof is urgently required to be further expanded. Introduction of advanced modulation formats and constellation shaping is an economical and effective solution for expanding capacity of a single channel, but the capacity of the single channel is ultimately limited by a nonlinear Shannon limit, and is not enough to support a capacity expansion requirement of the network. A multi-band optical network introducing new bands for transmission is a promising solution, can expand the capacity of the deployed optical network by using the whole communication window of a standard single-mode fiber (SSMF), and proves to be a short-term and medium-term preferred solution for capacity expansion of the optical network.

In the multi-band optical network, different signal channels may be unevenly affected by interactions between Kerr nonlinearity effect, amplified spontaneous emission noise effect and stimulated Raman scattering effect, and in such a system, a power profile of the signal channel may assume any shape. In order to guarantee quality of a transmitted signal and optimize information rates in multiple bands, it is necessary to be able to realize an ultra-fast reconfiguration of a gain profile.

A fiber Raman amplifier is an optical amplifier based on a nonlinear optical effect, has a quite low noise index compared with other types of optical amplifiers, and can ensure high-quality transmission of the signal. More importantly, the fiber Raman amplifier allows a flexible gain profile design by adjusting pump power and wavelength, provides gain availability in a multi-band range during running in a multi-pump configuration, and is well suited for realizing any gain profile in the multi-band optical network in a controlled manner.

However, in a commercial Raman pump module, pump wavelengths and the number of pumps are set in advance, an adjustable parameter is only the pump power, and the limited pump adjustment parameter cannot support the Raman amplifier in realizing any precise gain on all wavelength channels of the whole amplification band. In actual optical transmission, not all channels have traffic transmission, and usually, only wavelength channels of some links are used, but in the prior art, pump parameter adjustment can only be performed on gains of all the channels, and targeted and precise control for the wavelength channels in specific, partial links cannot be guaranteed.

### SUMMARY

In view of this, embodiments of the present disclosure provide a Raman gain adaptive control method and system for multi-band optical network, so as to eliminate or improve one or more defects in the prior art.

In an aspect, the present disclosure provides a Raman gain adaptive control method for multi-band optical network, including:
acquiring target gain values of target channels, supplementing gain values of non-target channels, constructing a gain vector based on the target gain values of the target channels and the supplemented gain values of the non-target channels, and performing at least one iteration;
in each iteration, inputting the values in the gain vector into a pre-trained inverse model, and outputting a corresponding pump adjustment parameter by the inverse model;
determining gain values of all channels based on the pump adjustment parameter, screening out gain values of the target channels from the gain values of all the channels, and calculating an objective function value based on the target gain values of the target channels and the gain values of the target channels screened out from the gain values of all the channels; and
adjusting the supplemented gain values of the non-target channels based on the objective function value, reconstructing the gain vector, performing a next iteration, and screening a final pump adjustment parameter from all the pump adjustment parameters after the last iteration is completed.

By adopting the above solution, the gain values of the non-target channels are randomly supplemented first, the corresponding pump adjustment parameter is obtained through the inverse model, and the gain values of all the channels are then determined based on the pump adjustment parameter. Since the pump adjustment parameter is related to the gain values of all the channels in the solution, the obtained pump adjustment parameter cannot necessarily correspond to the gain values of the target channels, and therefore, the objective function value is further calculated based on the target gain values of the target channels and the gain values of the target channels screened from the gain values of all the channels. By processing the objective function value for the target channel, the final pump adjustment parameter is determined through the multiple iterations, and pertinence to specified wavelength channels of a link is guaranteed.

In some embodiments of the present disclosure, the step of supplementing gain values of non-target channels includes: taking random values in a preset gain interval or supplementing a gain value of a non-target channel based on the target gain values of two adjacent target channels of the non-target channel, to obtain the supplemented gain values of the non-target channels;

the step of supplementing a gain value of a non-target channel based on the target gain values of two adjacent target channels of the non-target channel includes: constructing a line chart based on all the channels and the target gain values of the target channels, the horizontal axis of the line chart representing channel number, and the vertical axis of the line chart representing the gain value; connecting points corresponding to the target gain values of the two adjacent target channels of the non-target channel, and taking the gain value represented by the vertical coordinate of the point on the connecting line corresponding to the horizontal coordinate position of a non-target channel as the supplemented gain value of the non-target channel.

In some embodiments of the present disclosure, the step of determining gain values of all channels based on the pump adjustment parameter includes: inputting the pump adjustment parameter into a preset forward model, and outputting the gain values of all the channels by the forward model.

In some embodiments of the present disclosure, the forward model and the inverse model both have a structure of a feedforward neural network, a random forest or a convolutional neural network.

In some embodiments of the present disclosure, the forward model and the inverse model of the solution may have various structures, and the structures include, but are not limited to, the structures of the feedforward neural network, the random forest and the convolutional neural network, and combinations of the structures of the feedforward neural network, the random forest and the convolutional neural network.

In some embodiments of the present disclosure, the method may further include: combining the inverse model and the forward model to obtain a combined model, calculating the loss function based on the estimated gain values and actual gain values, and training the combined model.

In some embodiments of the present disclosure, the step of calculating an objective function value based on the target gain values of the target channels and the gain values of the target channels screened out from the gain values of all the channels includes:
calculating a root mean square error based on the target gain values of the target channels and the gain values of the target channels screened out from the gain values of all the channels; and
calculating the objective function value based on the root mean square error.

In some embodiments of the present disclosure, in the step of calculating the objective function value based on the root mean square error, if a genetic algorithm is adopted, the objective function value is a fitness value, and the step of calculating the objective function value based on the root mean square error includes: calculating the objective function value based on the following formula:

$$S = \frac{1}{R M S {E}_{{C}_{k n o w n}}} ;$$

wherein S is the calculated objective function value, RMSE_{C}_{_{known}} is the calculated root mean square error, and C_{known} represents the target channel.

In some embodiments of the present disclosure, the step of screening a final pump adjustment parameter from all the pump adjustment parameters after the last iteration is completed is achieved by adopting a first screening strategy or a second screening strategy, the first screening strategy including: a preset number of iterations are set, and one group of pump adjustment parameters are screened out as the final pump adjustment parameters when all the iterations are completed; and the second screening strategy including: determining the final pump adjustment parameters in an iteration process based on a preset screening threshold.

In some embodiments of the present disclosure, the step of screening out one group of pump adjustment parameters as the final pump adjustment parameters includes: taking the pump adjustment parameters corresponding to a highest fitness value as the final pump adjustment parameters.

In some embodiments of the present disclosure, the step of determining the final pump adjustment parameters in an iteration process based on a preset screening threshold includes: after each iteration is completed, comparing the calculated fitness value with the preset fitness threshold, and if the calculated fitness value is greater than the preset fitness threshold, taking this iteration as the last iteration, and outputting the pump adjustment parameters of this iteration as the final pump adjustment parameters.

In a second aspect, the present disclosure further provides a Raman gain adaptive control system for multi-band optical network, including a computer device, the computer device including a processor and a memory, the memory having computer instructions stored therein, the processor being configured to execute the computer instructions stored in the memory, and when the computer instructions are executed by the processor, the system implementing the steps of the above method.

In a third aspect, the present disclosure further provides a computer-readable storage medium having a computer program stored thereon, the computer program, when executed by a processor, implementing the steps of the above Raman gain adaptive control method for multi-band optical network.

Additional advantages, objects and features of the present disclosure will be set forth in part in the description which follows and in part will become apparent to those having ordinary skill in the art upon examination of the following or may be learned from practice of the present disclosure. The objects and other advantages of the present disclosure will be particularly pointed out and attained in the specification and drawings.

It will be appreciated by those skilled in the art that the objects and advantages that can be achieved with the present disclosure are not limited to what has been particularly described hereinabove, and that the above and other objects that can be achieved with the present disclosure will be more clearly understood from the following detailed description.

### BRIEF DESCRIPTION OF THE DRAWINGS

The accompanying drawings described herein are used to provide a further understanding of the present disclosure, constitute a part of the present disclosure, and do not limit the present disclosure.

FIG. 1 is a schematic diagram of a Raman gain adaptive control method for multi-band optical network according to an embodiment of the present disclosure;

FIG. 2 is a schematic diagram of a Raman gain adaptive control method for multi-band optical network according to another embodiment of the present disclosure;

FIG. 3 is a schematic diagram of the system application of a Raman gain adaptive control method for multi-band optical network according to the present disclosure;

FIG. 4 is a schematic diagram of a configuration profile of an embodiment of the present disclosure; and

FIG. 5 is a schematic diagram of another configuration profile of an embodiment of the present disclosure.

### DETAILED DESCRIPTION

In order to make the objectives, technical solutions and advantages of the present disclosure more apparent, the present disclosure is described in further detail below with reference to the embodiments and the accompanying drawings. Herein, the exemplary embodiments of the present disclosure and the descriptions thereof are used to explain the present disclosure, but not to limit the present disclosure.

It should also be noted herein that, in order to avoid obscuring the present disclosure with unnecessary details, only the structures and/or processing steps closely related to the solution according to the present disclosure are shown in the drawings, and other details not so related to the present disclosure are omitted.

For a programmable Raman amplifier, multi-channel means it can amplify signals at different wavelengths as needed while maintaining independence and stability between channels. The gain effect of each channel is related to the pump adjustment parameters. In the prior art, only limited pump adjustment parameters for the gain of all wavelength channels can be adjusted, it is impossible to ensure targeted adjustments for specific wavelength channels in partial links. Therefore, the present disclosure provides a Raman gain adaptive control method that can automatically achieve specified wavelength channel gain for programmable Raman amplifiers under limited pump adjustment resources. This ensures gain generation accuracy on traffic transmission wavelength channels and breaks through the limitations in gain generation of programmable Raman amplifiers caused by constrained pump adjustment resources.

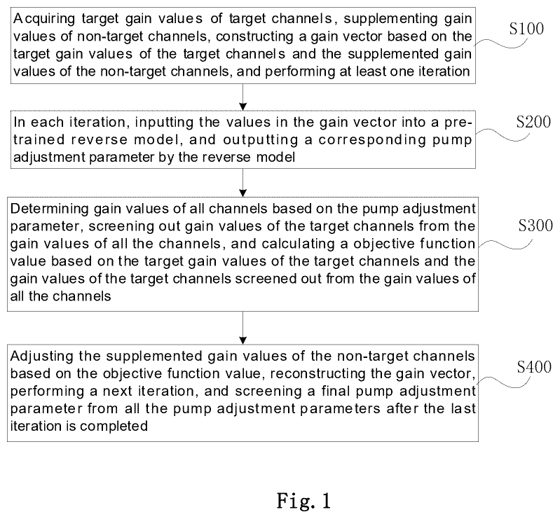

As shown in FIG. 1, the present disclosure provides a Raman gain adaptive control method for multi-band optical network. The method can be achieved by a Raman gain adaptive control system, and the method includes:

step S100: acquiring target gain values of target channels, supplementing gain values of non-target channels, constructing a gain vector based on the target gain values of the target channels and the supplemented gain values of the non-target channels, and performing at least one iteration.

In the embodiments of the present disclosure, the target channel refers to a channel with specific gain requirements (for example, a channel with traffic transmission), which is a channel for high-precision gain configuration and may also be referred to as a designated wavelength channel or abbreviated as a designated channel. The non-target channel refers to a channel without specific gain requirements, also referred to as a non-designated wavelength channel. In this step, the gain values of the non-specified wavelength channels are filled by a set filling rule, and a target profile space containing a series of gain values and passing through the target gain value of a designated target channel is obtained. The target gain value of the target channel can be obtained from the target parameters input into the system. The input target parameters include the wavelengths of the channels with gain requirements, the number of channels, and the target gain value(s) of the designated channel(s).

As an example, the set filling rule is used to set the gain values for the non-target channels based on the target gain value(s) of the designated channel(s), thereby forming a complete gain profile. The gain values setting for non-target channels may fluctuate within a certain range, and the series of gain profiles (which can be referred to as configuration profiles) formed in this way can constitute a gain profile space, i.e., the target profile space.

For each gain profile, the target gain values of the target channels and the supplementary gain values of non-target channels can be treated as values across different dimensions within a gain vector, thereby constructing said gain vector.

Step S200: in each iteration, inputting the values in the gain vector into a pre-trained inverse model, and outputting a corresponding pump adjustment parameter by the inverse model.

The output pump adjustment parameters may include the pump wavelength, the number of pumps, and pump power of the programmable Raman amplifier. Considering the compatibility of current commercial Raman amplifiers, it is also possible to only set the pump power to be adjustable.

In the embodiments of the present disclosure, the pre-trained inverse model is an inverse mapping model constructed and trained based on machine learning according to the number of pumps in the programmable Raman amplifier and the number of wavelength channels in the optical transmission system. The pre-trained inverse model characterizes the mapping relationship between Raman gain profiles and the pump configuration parameters. The constructed model can be trained and tested separately based on training datasets and testing datasets collected in specific scenarios, and the trained model can serve as a pump prediction model.

Step S300: determining gain values of all channels based on the pump adjustment parameter, screening out a gain value of the target channel from the gain values of all the channels, and calculating an objective function value based on the target gain value of the target channel and the gain value of the target channel screened out from the gain values of all the channels.

In some embodiments of the present disclosure, the step of determining gain values of all channels based on the pump adjustment parameter can be achieved by using a pre-constructed gain estimation model of a multi-band programmable Raman amplifier for providing real-time feedback, and the evaluation of the quality of profiles in the target profile space can be completed based on this model. The modeling process of the gain estimation model can be realized based on numerical modeling, simulation modeling and machine learning pre-training modes, in a single or combined manner, so as to realize simulation of pump prediction and amplification processes of the programmable Raman amplifier, and the effect that the pump prediction and amplification processes of the programmable Raman amplifier can be accurately simulated should be achieved. That is, a gain profile generated by a real programmable Raman amplifier and a gain profile generated by the simulation process should be consistent as much as possible under the condition of a same input gain profile. After all the configuration profiles in the target profile space pass through the gain estimation model of the programmable Raman amplifier, a newly generated profile space composed of a plurality of newly generated profiles that correspond one-to-one with the configuration profiles is obtained, and differences between the configuration profiles and the generated profiles in one-to-one correspondence thereto are used as measurement indexes of a gain generation effect of the programmable Raman amplifier.

Step S400: adjusting the supplemented gain values of the non-target channels based on the objective function value, reconstructing the gain vector for input into the pre-trained inverse model in the next iteration. After completing the final iteration, the pump adjustment parameters output from the inverse model are the final pump adjustment parameters selected from all pump adjustment parameters.

In this step, an optimization objective function can be utilized to adjust the supplemented gain values for non-target channels based on the objective function value. This optimization objective function can be employed to maximize the accuracy of Raman gain generation for the specified wavelength channels.

In some embodiments of the present disclosure, the optimization objective function can also be dynamically adaptively adjusted during the optimization process according to changes in the specified channels to ensure a high degree of matching between the optimization process and the channel specification status or channel occupancy conditions.

Specifically, based on feedback provided by the constructed gain estimation model, Raman gain control optimization is performed on the target profile space according to input target parameters. That is, profiles in the target profile space containing the specified channel target gain values are screened and optimized until a profile with an optimal gain generation effect is found, and the found profile is used as an output result of the optimization method. The feedback refers to the accuracy of gain generation on a specified wavelength channel when the current target gain profile is used as the input of a programmable Raman amplifier. When the profile with an optimal gain generation effect is used as input to the programmable Raman amplifier, the profile can realize best gain generation precision over the specified wavelength channel.

The optimal profile found by Raman gain control and optimization is taken as an input target gain profile of the programmable Raman amplifier, and a gain control process can be completed by the programmable Raman amplifier based on the profile through pump prediction and instruction issuance.

A propagation equation of the Raman amplifier needs to consider distribution of forward pumping, backward pumping, signals and amplified spontaneous emission (ASE) noise power, and a nonlinear differential equation satisfied by the propagation is as follows:

$$\frac{{dP}^{\pm } ( z , {v}_{i} \}}{dz} = ∓ \partial ( {v}_{i} ) {P}^{\pm } ( z , {v}_{i} ) \pm η ( {v}_{i} ) \pm {P}^{\pm } ( z , {v}_{i} ) {\sum }_{m = 1}^{i - 1} \frac{{g}_{R} ( {v}_{m} - {v}_{i} )}{Γ {A}_{eff}} [ {P}^{\pm } ( z , {v}_{m} ) + {P}^{\pm } ( z , {v}_{m} ) ] \pm {hv}_{i} {\sum }_{m = 1}^{i - 1} \frac{{g}_{R} ( {v}_{m} - {v}_{i} )}{Γ {A}_{eff}} [ {P}^{\pm } ( z , {v}_{m} ) + {P}^{∓} ( z , {v}_{m} ) ] [ 1 + {( {e}^{\frac{h ( {v}_{m} - {v}_{i} )}{kT}} - 1 )}^{- 1} ] Δ v ∓ {P}^{\pm } ( z , {v}_{i} ) {\sum }_{m = i + 1}^{n} \frac{{v}_{i}}{{v}_{m}} \frac{{g}_{R} ( {v}_{i} - {v}_{m} )}{Γ {A}_{eff}} [ {P}^{\pm } ( z , {v}_{m} ) + {P}^{∓} ( z , {v}_{m} ) ] ∓ 2 h {v}_{i} {P}^{\pm } ( z , {v}_{i} ) {\sum }_{m = i + 1}^{n} \frac{{v}_{i}}{{v}_{m}} \frac{{g}_{R} ( {v}_{i} - {v}_{m} )}{Γ {A}_{e f f}} [ 1 + {( {e}^{\frac{h ( {v}_{m} - {v}_{i} )}{k T}} - 1 )}^{- 1} ] Δ v$$

wherein P⁺(z, vᵢ) and P^{∧}-(z, vᵢ) are forward and backward transmission optical power around a frequency vᵢ, respectively; z is the propagation distance along the fiber; α, η, h, k and T are optical fiber attenuation coefficient, Rayleigh scattering coefficient, Planck constant, Boltzmann constant and absolute temperature respectively; A_{eff} is the effective area of the optical fiber at the frequency vₘ; g_{R} is Raman gain coefficient; and Γ is polarization factor.

In some embodiments of the present disclosure, the present disclosure adopts a genetic algorithm, an initial population is constructed based on the target gain values of the target channels and the supplemented gain values of the non-target channels, fitness is calculated in each iteration, and the population is updated so as to complete the iteration. An optimal individual is iteratively found out through continuous selection, crossover and mutation, and the individual is used as output of the algorithm. The adaptive Raman gain control method based on a genetic algorithm in the embodiments of the present disclosure is applicable to programmable Raman amplifiers containing multiple pumps. It is used to identify input gain profiles that can achieve optimal gain generation effects on specific channels, thereby precisely meeting users' gain requirements for those particular channels.

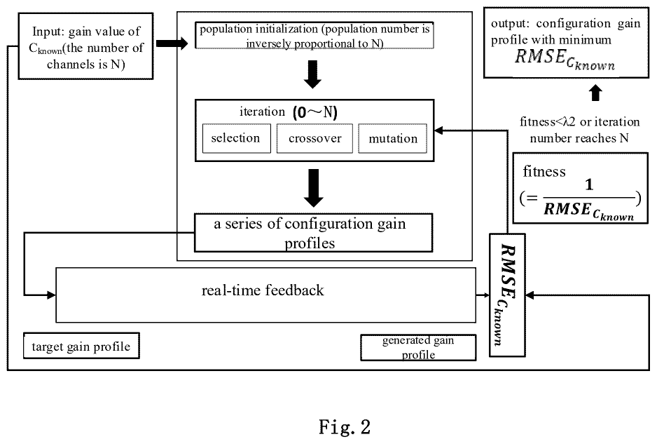

In some embodiments of the present disclosure, as shown in FIG. 2, the selection, crossover and mutation are circularly executed, and individuals in the population are continuously evaluated until a termination condition for the iteration is met or a set number of iterations are completed. The selection operation is performed first, so as to select excellent individuals from the current population to provide a basis for the subsequent crossover and mutation operations. The selection process is typically based on the fitness of the individual, and the individual with higher fitness is selected with a higher probability. As an example, the fitness can be derived based on the feedback (objective function value) provided in step S300. The objective function value in step S300 is the Root Mean Square Error (RMSE) between the target gain values of the target channels and the gain values of the target channels selected from the gain values of all channels. In the present disclosure. The fitness is calculated based on a reciprocal of an RMSE, and therefore, the selection process favors individuals with corresponding generated gain profiles having small errors relative to the target gain on the specified wavelength channel. The crossover operation is performed on the gain profiles of selected parent individuals, and new gain profiles are generated by exchanging gain values of some wavelength channels thereof, thereby introducing new genetic diversity while preserving superior characteristics in the parent individuals. Finally, the gain profile of the individual is adjusted in a small range through the mutation operation, that is, the gain value of the specific wavelength channel is finely adjusted, so as to prevent the algorithm from being prematurely converged to a local optimal solution, and keep the diversity of the population. It should be noted that the crossover and mutation operations are only performed on the unspecified wavelength channels, and the target gain value is always kept constant for the specified wavelength channel. An initial iteration number is set, and an iteration optimization threshold and an iteration termination threshold are set. Once the fitness of one individual is found to exceed the iteration optimization threshold, the iteration is properly accelerated; when the fitness of one individual is found to be larger than the termination threshold, the iteration is stopped, and the individual is output as a result. Otherwise, the iteration is continuously performed until the set number of initial iterations are finished, and the optimal individual in the iteration process is output as a final result.

In some embodiments of the present disclosure, by adaptively optimizing the target gain of the programmable Raman amplifier on some specified transmission channels, high gain generation precision on the specified wavelength channel is realized, full utilization of limited pump resources is realized to maximize the gain generation precision of the multi-band programmable Raman amplifier on the specific wavelength channel, the problem of limited generation precision of any gain of a full wavelength channel caused by a small number of adjustable parameters of the programmable Raman amplifier is solved, and an application and effective deployment of the programmable Raman amplifier are promoted.

The present disclosure is suitable for various optical transmission scenes, including but not limited to multi-band fixed grid optical network transmission systems, multi-band flexible grid optical network transmission systems, multi-band ultra-long distance transmission systems, or the like, which have urgent needs on adaptive control over the gain of the multi-band optical network amplifier due to large transmission bandwidths and uneven transmission spectra.

By adopting the above solution, the gain values of the non-target channels are randomly supplemented first, the corresponding pump adjustment parameter is obtained through the inverse model, and the gain values of all the channels are then determined based on the pump adjustment parameter until the fitness meets a requirement. Since the pump adjustment parameter is related to the gain values of all the channels in the solution, the corresponding pump adjustment parameter is solved through supplementation of gain values, but the obtained pump adjustment parameter may not necessarily correspond to the gain values of the target channels, and therefore, the objective function value is further calculated based on the target gain values of the target channels and the gain values of the target channels screened from the gain values of all the channels, and the supplemented gain values of the non-target channels are further adjusted using the calculated objective function value to reconstruct the gain vector as the input of the inverse model and output updated pump adjustment parameter. The final pump adjustment parameter is determined through the multiple iterations, and pertinence to the specified wavelength channel of a link is guaranteed.

In some embodiments of the present disclosure, the specific filling process of step S100 is as follows: fixing the target gain values of the specified wavelength channels unchanged, filling the gain values of the non-specified wavelength channels according to a specified filling rule, so as to obtain a plurality of gain profiles through different packing values to form the initial population, thereby completing initialization of the population. The specified filling rule is as follows: when finding nearest channels with gain requirements on two sides of the channel to be filled with a gain value, a value that falls on the two-point line connecting the gain values of the two nearest channels with gain requirements will be used as a reference gain, and the filling value randomly oscillates in a set range above and below the reference gain. Each individual in the initial population is one complete gain profile and is composed of the target gain values of the specified wavelength channels and the filling gain values of the non-specified wavelength channels. The gain values represent different combinations of gain values for non-specified wavelength channels and the target gain values for the specified wavelength channels. Each individual in the population (i.e., the gain profile) is input into the model of the simulated programmable amplifier for real-time feedback, resulting in a corresponding generated profile. The standard deviation between the input profile and the generated profile on the channels with gain requirements is recorded as the RMSE. The fitness function of the algorithm is set as the reciprocal of the RMSE. This means that if an individual has a small RMSE value, it indicates that the gain values generated by its corresponding gain profile closely matches the gain profile in terms of gain values at the specified wavelength channels. As a result, its fitness function value (i.e., the reciprocal of the RMSE) will be larger, signifying that it is a high-quality individual. Conversely, if the RMSE value is large, the fitness function value will be small, indicating a poor-performing individual. Provided the real-time feedback model is sufficiently accurate, this metric can effectively evaluate the performance of a given configuration profile in generating gain on user-specified channels after passing through the programmable Raman amplifier. This process involves creation of the initial population and determines initial diversity of an algorithm search solution space. In this step, the number of the initial populations is set to be negatively correlated with the number of the channels with the gain requirement. This means that when there are a large number of channels with the gain requirement, there are a small number of positions where the target gain can fluctuate, and the number of the initial populations can be relatively small, thereby reducing algorithm retrieval complexity; when there are a small number of channels with the gain requirement, the gain values of the target gain profile over many wavelength channels may fluctuate, and the number of the initial populations is relatively large, thereby providing more candidate solutions for the algorithm to explore the optimal gain profile.

In some embodiments of the present disclosure, in the step of constructing a gain vector based on the target gain values of the target channels and the supplemented gain values of the non-target channels, the supplemented gain values of the non-target channels are obtained by taking random values in a preset gain interval or supplementing the gain values of the non-target channels based on the target gain values of two adjacent target channels of the non-target channels.

the step of supplementing the gain values of the non-target channels based on the target gain values of two adjacent target channels of the non-target channel includes: constructing a line chart based on all the channels and the target gain values of the target channels, a horizontal axis of the line chart representing channel number, and a vertical axis of the line chart representing gain value; connecting points corresponding to the target gain values of the two adjacent target channels of the non-target channel, and taking the gain value represented by the vertical coordinate of the point on the connecting line corresponding to the horizontal coordinate position of a non-target channel as the supplemented gain value of the non-target channel.

In some embodiments of the present disclosure, the step of determining gain values of all channels based on the pump adjustment parameter includes: inputting the pump adjustment parameter output from the inverse model into a pre-trained forward model, and outputting the gain values of all the channels by the forward model.

In some embodiments of the present disclosure, the pre-trained forward model is a forward mapping model that characterizes the mapping relationship between pump configuration parameters and Raman gain profiles, which can be constructed and trained based on machine learning.

In some embodiments of the present disclosure, the forward model and the inverse model may both have but not limited to a structure of a feedforward neural network, a random forest or a convolutional neural network. Preferably, both forward and inverse models use feedforward neural networks. The training process of the forward model may include applying pump adjustment parameters to a programmable Raman amplifier to obtain actual gain values, calculating a loss function based on the actual gain values and estimated gain values, and training the forward model.

In the embodiments of the present disclosure, pump adjustment parameters can first be output through the inverse model. However, since the obtained pump adjustment parameters may not necessarily correspond to the target gain values of each channel, estimated gain values corresponding to these pump adjustment parameters are then derived via the forward model, and based on the difference between the target gain values and the estimated gain values, the discrepancy in gain values (target parameter value) is determined. This enables fast and accurate estimation of the gain of the programmable Raman amplifier, providing effective feedback support for wide-spectrum optical power amplification and flexible control of the gain profile of the programmable Raman amplifier.

During the pre-training process of the inverse model and the forward model, batch data collection is performed in optical transmission scenarios to construct training datasets and test datasets. The constructed datasets include multiple sets of gain profiles of the programmable Raman amplifier and their corresponding pump configuration parameters in such scenarios. The pump configuration parameters may include: the pump wavelength, the number of pumps, and pump power of the programmable Raman amplifier. The data collection process is as follows: an optical transmission scenario containing the programmable Raman amplifier is designed, and based on a simulation platform, hardware equipments, the fiber Raman amplifier transmission equation, or a Raman operator, gain profiles under different pump configuration parameters of programmable Raman amplifier in this scenario are obtained. During the data collection process, a hierarchical sampling rule can be adopted, i.e., pump adjustment parameters are set through hierarchical sampling, mixing pump configuration parameters with large and small sampling intervals to reduce data redundancy and improve sampling efficiency.

During the pre-training process of the inverse model and the forward model, the inverse model and the forward model can use training datasets containing a large number of samples, and model parameters are optimized through cross-validation methods. The constructed models include multiple hidden layers, each containing several hidden units, with preset activation functions and learning rates.

The present disclosure may also combine the inverse model and the forward model to form a combined model, where the inverse model is placed before the forward model. The combined model can achieve accurate pump prediction and amplification process simulation for the programmable Raman amplifier, thereby providing real-time feedback for the optimization process of channel-adaptive Raman gain control.

In the embodiments of the present disclosure, the inverse model and the forward model can be connected to form a dual-symmetric model. The input of this dual-symmetric model structure is a target gain value, and the output is the estimated gain value after two-stage mapping. Based on a chain rule of derivatives, the weights of the cascaded dual-symmetric model are fine-tuned using a small amount of data to improve the stability and accuracy of the model. The included pump prediction model will predict the corresponding pump configuration parameters based on the input gain value, and transmit the predicted pump configuration parameters to the included gain prediction model to obtain the predicted Raman gain under these pump configuration parameters, thereby achieving fast estimation of the gain of the wide-spectrum programmable Raman amplifier.

In a specific implementation process, the gain estimation model of the multi-band programmable Raman amplifier for providing real-time feedback is constructed. This step is the key to subsequent control and optimization, and the modeling process can be realized in the single or combined mode based on the numerical modeling, simulation modeling and machine learning pre-training modes, so as to realize simulation of pump prediction and amplification of the programmable Raman amplifier. In an embodiment of the present disclosure, modeling is performed based on a machine learning method, and the model which can perform pump accurate prediction and accurate simulation of the amplification process of the programmable Raman amplifier is obtained by a pre-trained machine learning model, so as to obtain the generated profiles of the programmable Raman amplifier corresponding to different target gain profiles. When this process is simulated based on the trained machine learning model, a large amount of data needs to be collected, and the data includes parameter settings of the programmable Raman amplifier at different pump configuration parameters and corresponding Raman gain profiles. The data can be generated by experimental measurement, simulation software or solving the propagation equation of the Raman amplifier, and data collection quality and diversity are also crucial to accuracy of the model. Meanwhile, a machine learning method suitable enough is required to be selected to construct the model, and complexity, training time, prediction accuracy and a generalization capability of the method are considered in the selection process. In an embodiment of present disclosure, the feedforward neural network is selected to construct the mode.

In some embodiments of the present disclosure, the step of calculating an objective function value based on the target gain value of the target channel and the gain value of the target channel screened out from the gain values of all the channels includes:
calculating a root mean square error based on the target gain value of the target channel and the gain value of the target channel screened out from the gain values of all the channels; and
calculating the objective function value based on the root mean square error.

In some embodiments of the present disclosure, the genetic algorithm, a reinforcement learning algorithm or a particle swarm algorithm is adopted to perform the iteration. Specifically, if the genetic algorithm is adopted, the objective function value is a fitness value, and the gain vector is the population; if the reinforcement learning algorithm is adopted, the objective function value is a reward function value; if the particle swarm algorithm is adopted, the objective function value is an adaptive value, and the gain vector is a particle swarm.

If the genetic algorithm is adopted, the objective function value is the fitness value, and in the step of calculating the objective function value based on the root mean square error, the objective function value is calculated based on the following formula:

$$S = \frac{1}{R M S {E}_{{C}_{k n o w n}}} ;$$

wherein S is the calculated objective function value, RMSE_{C}_{_{known}} is the calculated root mean square error, and C_{known} represents the target channel.

In some embodiments of the present disclosure, the step of screening a final pump adjustment parameter from all the pump adjustment parameters after completing the last iteration is achieved by adopting a first screening strategy or a second screening strategy, the first screening strategy including: setting a preset number of iterations, and screening out one group of pump adjustment parameters as the final pump adjustment parameters when all the iterations are completed; and the second screening strategy including: determining the final pump adjustment parameters in an iteration process based on a preset screening threshold.

In some embodiments of the present disclosure, in the step of screening out one group of pump adjustment parameters as the final pump adjustment parameters, the pump adjustment parameters corresponding to a highest fitness value is taken as the final pump adjustment parameters.

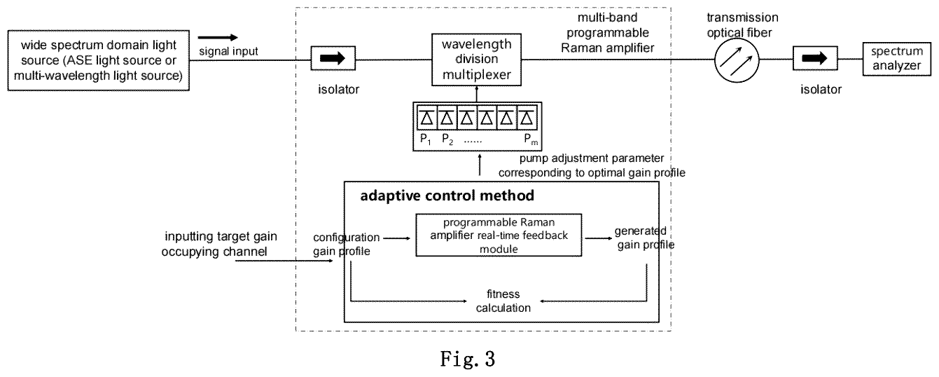

FIG. 3 illustrates the application process of the Raman gain adaptive control method for multi-band optical networks according to the present invention. As shown in FIG. 3, a broadband light source (typically an ASE source or multi-wavelength source) serves as the signal input and passes through an isolator into the programmable Raman amplifier. The programmable Raman amplifier is internally equipped with a wavelength division multiplexer that couples each pump light into signal paths. The amplified signal enters the transmission fiber and, at the output end, passes through an isolator into an optical spectrum analyzer to obtain the measured gain profile. The amplifier incorporates the “adaptive control method” module described in the present invention. This module receives target parameters and supplements the gain values of non-target channels according to predefined rules to construct a gain vector. Subsequently, during multiple iterations, the objective function value is calculated based on feedback results, and the supplemental gain values for non-target channels are continuously adjusted to dynamically update the gain vector. Once the convergence criteria are met, the optimal pump adjustment parameters are ultimately selected. These parameters are distributed to each pump channel, enabling adaptive gain control for the target channels, thereby ensuring high-precision gain generation under limited pump resources.

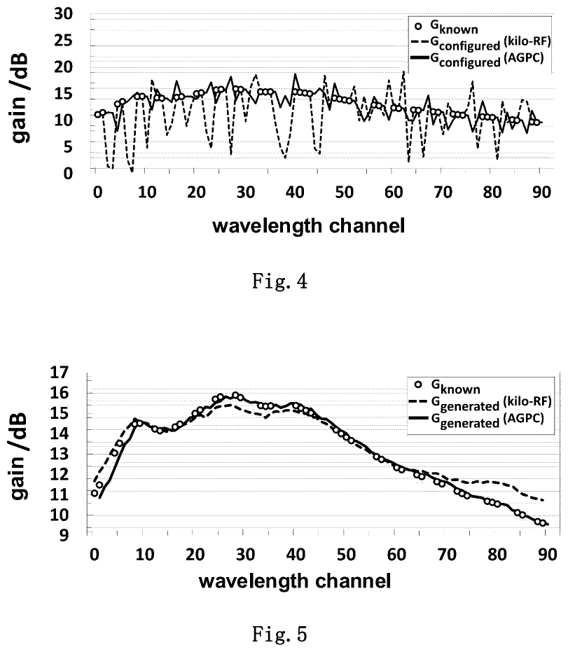

In some embodiments of the present disclosure, if the gain values of non-target channels are randomly selected within a preset gain interval (i.e. random configuration), 1000 iterations are set to obtain 1000 configuration profiles, and one of the 1000 configuration profiles with the best configuration effect is selected, represented as G_{configured} (kilo-RF) in FIG. 4, which represents being obtained by random value selecting; If the gain value of a non-target channel is supplemented based on the target gain values of two adjacent target channels and the method proposed in this application is adopt for adaptive gain profile control, the resulting configuration profile is G_{configured} (AGPC) as shown in FIG. 4. Profile G_{known} in FIG. 4 represents the target gain profile. Two generated profiles obtained by subjecting the two configuration profiles G_{configured} (kiloRF) and G_{configured} (AGPC) to the simulation process of the programmable Raman amplifier are shown in FIG. 5. The result shows that compared with the optimal configuration result in the 1,000 random configurations, the gain values of the generated profile corresponding to G_{configured} (AGPC) on the specified channels are closer to the target gain value, and higher gain generation accuracy is achieved.

In some embodiments of the present disclosure, in the step of determining the final pump adjustment parameters in an iteration process based on a preset screening threshold, after each iteration is completed, comparing the calculated fitness value with the preset fitness threshold, and if the calculated fitness value is greater than the preset fitness threshold, taking this iteration as the last iteration, and outputting the pump adjustment parameters of this iteration as the final pump adjustment parameters.

The present disclosure breaks through an application limit of the current programmable Raman amplifier, so that novel requirements of the multi-band optical network for the optical amplifier can be met. That is, by ensuring the gain generation accuracy on the specified wavelength channel and effectively utilizing the programmable Raman amplifier with limited pump resources, it can alleviate the signal transmission quality degradation caused by the introduction of new bands and ensure the expansion effect of multi-band optical network.

The present disclosure realizes the high gain generation precision on the specified wavelength channel by searching one optimal input profile for the programmable Raman amplifier, and breaks through the application limit of the programmable Raman amplifier caused by the small number of pump adjustment parameters. Meanwhile, the method can feed back the gain generation effect in real time for users, so that the users can properly adjust the target gain according to the generation effect, and stable running of the amplification process is guaranteed.

The present disclosure has the following beneficial effects.

1. The present disclosure can realize dynamic optimization and the high gain generation precision: a real transmission state of the network is adapted in real time through adaptive control, a high-precision gain configuration of the specific wavelength channel is realized under the limited pump resources, the problem that the generation precision of any gain of the full wavelength channel is limited due to the small number of pump adjustment parameters is solved, and a wide application of the programmable Raman amplifier is promoted.

2. The present disclosure can realize real-time feedback: the gain generation effect can be fed back in real time for the user, so that the user can properly adjust the target gain according to the generation effect, and stable running of the amplification process is guaranteed.

3. Furthermore, a dual-symmetric model structure is proposed. By performing step-by-step modeling for the second-order process involving pump prediction and amplification, combined reconstruction, and weight fine-tuning of the cascaded model in programmable Raman amplifiers, effective simulation of the second-order process and accurate estimation of the gain in programmable Raman amplifiers are achieved.

An embodiment of the present disclosure further provides a Raman gain adaptive control system for multi-band optical network, including a computer device, the computer device including a processor and a memory, the memory having computer instructions stored therein, the processor being configured to execute the computer instructions stored in the memory, and when the computer instructions are executed by the processor, the system implementing the steps of the above method.

An embodiment of the present disclosure further provides a computer-readable storage medium having a computer program stored thereon, the computer program, when executed by a processor, implementing the steps of the above Raman gain adaptive control method for multi-band optical network. The computer-readable storage medium may be a tangible storage medium, such as a random access memory (RAM), a memory, a read only memory (ROM), an electrically programmable ROM, an electrically erasable programmable ROM, a register, a floppy disk, a hard disk, a removable storage disk, a CD-ROM, or any other form of storage medium known in the art.

Those of ordinary skill in the art should appreciate that the various exemplary components, systems and methods described in connection with the embodiments disclosed herein may be implemented in hardware, software, or combinations thereof. Whether they are implemented in hardware or software depends upon particular applications and design constraints of the technical solution. Professionals may use different methods for particular applications to achieve the described functions, but such implementations should not be considered beyond the scope of the present disclosure. When implemented in hardware, the elements of the present disclosure may be, for example, an electronic circuit, an application specific integrated circuit (ASIC), suitable firmware, plug-in, a function card, or the like. When implemented in software, the elements of the present disclosure are programs or code segments used to perform required tasks. The programs or the code segments can be stored in a machine-readable medium or transmitted by a data signal carried in a carrier wave over a transmission medium or a communication link.

It is to be understood that the present disclosure is not limited to the particular configurations and processing described above and shown in the drawings. A detailed description of known methods is omitted herein for the sake of brevity. In the above embodiments, several specific steps are described and shown as an example. However, the method processes of the present disclosure are not limited to the specific steps described and shown, and those skilled in the art can make various changes, modifications and additions, or change the order between the steps, after comprehending the spirit of the present disclosure.

Features that are described and/or illustrated with respect to one embodiment may be used in the same way or in a similar way in one or more other embodiments and/or in combination with or instead of the features of the other embodiments in the present disclosure.

The above description is only a preferred embodiment of the present disclosure and is not intended to limit the present disclosure, and various modifications and changes may be made to the embodiment of the present disclosure by those skilled in the art. Any modifications, equivalents and improvements made within the spirit and principle of the present disclosure should be included in the protection scope of the present disclosure.

1. A Raman gain adaptive control method for multi-band optical network, comprising:
acquiring target gain values of target channels, supplementing gain values of non-target channels, constructing a gain vector based on the target gain values of the target channels and the supplemented gain values of the non-target channels, and performing at least one iteration;
in each iteration, inputting the values in the gain vector into a pre-trained inverse model, and outputting a corresponding pump adjustment parameter by the inverse model;
determining gain values of all channels based on the pump adjustment parameter, screening out gain values of the target channels from the gain values of all the channels, and calculating an objective function value based on the target gain values of the target channels and the gain values of the target channels screened out from the gain values of all the channels; and
adjusting the supplemented gain values of the non-target channels based on the objective function value, reconstructing the gain vector, performing a next iteration, and screening a final pump adjustment parameter from all the pump adjustment parameters after the last iteration is completed.

2. The Raman gain adaptive control method for multi-band optical network according to claim 1, wherein the step of supplementing gain values of non-target channels comprises: taking a random value in a preset gain interval or supplementing a gain value of a non-target channel based on the target gain values of two adjacent target channels of the non-target channel, to obtain the supplemented gain values of the non-target channels;
the step of supplementing the gain values of the non-target channels based on the target gain values of two adjacent target channels of the non-target channel comprises: constructing a line chart based on all the channels and the target gain values of the target channels, a horizontal axis of the line chart representing channel number, and a vertical axis of the line chart representing gain value; connecting points corresponding to the target gain values of the two adjacent target channels of the non-target channel, and taking the gain value represented by the vertical coordinate of the point on the connecting line corresponding to the horizontal coordinate position of a non-target channel as the supplemented gain value of the non-target channel.

3. The Raman gain adaptive control method for multi-band optical network according to claim 1, wherein the step of determining gain values of all channels based on the pump adjustment parameter comprises: inputting the pump adjustment parameter into a preset forward model, and outputting the gain values of all the channels by the forward model.

4. The Raman gain adaptive control method for multi-band optical network according to claim 3, wherein the forward model and the inverse model both have a structure of a feedforward neural network, a random forest or a convolutional neural network.

5. The Raman gain adaptive control method for multi-band optical network according to claim 3, further comprising:
combining the inverse model and the forward model to obtain a combined model, calculating the loss function based on the estimated gain value and an actual gain value, and training the combined model.

6. The Raman gain adaptive control method for multi-band optical network according to claim 1, wherein the step of calculating an objective function value based on the target gain values of the target channels and the gain values of the target channels screened out from the gain values of all the channels comprises:
calculating a root mean square error based on the target gain values of the target channels and the gain values of the target channels screened out from the gain values of all the channels; and
calculating the objective function value based on the root mean square error.

7. The Raman gain adaptive control method for multi-band optical network according to claim 6, wherein if a genetic algorithm is adopted, the objective function value is a fitness value, and the step of calculating the objective function value based on the root mean square error comprises: calculating the objective function value based on the following formula:
$$S = \frac{1}{R M S {E}_{{C}_{k n o w n}}} ;$$
wherein S is the calculated objective function value, RMSE_{C}_{_{known}} is the calculated root mean square error, and C_{known} represents the target channel.

8. The Raman gain adaptive control method for multi-band optical network according to claim 1, wherein the step of screening a final pump adjustment parameter from all the pump adjustment parameters after the last iteration is completed by adopting a first screening strategy or a second screening strategy, the first screening strategy comprising: a preset number of iterations are set, and one group of pump adjustment parameters are screened out as the final pump adjustment parameters when all the iterations are completed; and the second screening strategy comprising: determining the final pump adjustment parameters in an iteration process based on a preset screening threshold.

9. The Raman gain adaptive control method for multi-band optical network according to claim 8, wherein if a genetic algorithm is adopted, the objective function value is the fitness value, and the step of screening out one group of pump adjustment parameters as the final pump adjustment parameters comprises: taking the pump adjustment parameters corresponding to a highest fitness value as the final pump adjustment parameters.

10. The Raman gain adaptive control method for multi-band optical network according to claim 8, wherein if a genetic algorithm is adopted, the objective function value is the fitness value, and the step of determining the final pump adjustment parameters in an iteration process based on a preset screening threshold comprises: after each iteration is completed, comparing the calculated fitness value with the preset fitness threshold, and if the calculated fitness value is greater than the preset fitness threshold, taking this iteration as the last iteration, and outputting the pump adjustment parameters of this iteration as the final pump adjustment parameters.

11. A Raman gain adaptive control system for multi-band optical network, comprising a computer device, the computer device comprising a processor and a memory, the memory having computer instructions stored therein, the processor being configured to execute the computer instructions stored in the memory, and when the computer instructions are executed by the processor, the system implementing the steps of:
acquiring target gain values of target channels, supplementing gain values of a non-target channels, constructing a gain vector based on the target gain values of the target channels and the supplemented gain values of the non-target channels, and performing at least one iteration;
in each iteration, inputting the values in the gain vector into a pre-trained inverse model, and outputting a corresponding pump adjustment parameter by the inverse model;
determining gain values of all channels based on the pump adjustment parameter, screening out gain values of the target channels from the gain values of all the channels, and calculating an objective function value based on the target gain values of the target channels and the gain values of the target channels screened out from the gain values of all the channels; and
adjusting the supplemented gain values of the non-target channels based on the objective function value, reconstructing the gain vector, performing a next iteration, and screening a final pump adjustment parameter from all the pump adjustment parameters after the last iteration is completed.

12. The Raman gain adaptive control system for multi-band optical network according to claim 11, wherein the step of supplementing gain values of non-target channels comprises: taking random values in a preset gain interval or supplementing the gain value of a non-target channel based on the target gain values of two adjacent target channels of the non-target channel, to obtain the supplemented gain values of the non-target channels;
the step of supplementing the gain value of a non-target channel based on the target gain values of two adjacent target channels of the non-target channel comprises: constructing a line chart based on all the channels and the target gain values of the target channels, the horizontal axis of the line chart representing channel number, and the vertical axis of the line chart representing gain value; connecting points corresponding to the target gain values of the two adjacent target channels of the non-target channel, and taking the gain value represented by the vertical coordinate of the point on the connecting line corresponding to the horizontal coordinate position of the non-target channel as the supplemented gain value of a non-target channel.

13. The Raman gain adaptive control system for multi-band optical network according to claim 11, wherein the step of determining gain values of all channels based on the pump adjustment parameter comprises: inputting the pump adjustment parameter into a preset forward model, and outputting the gain values of all the channels by the forward model.

14. The Raman gain adaptive control system for multi-band optical network according to claim 13, wherein the forward model and the inverse model both have a structure of a feedforward neural network, a random forest or a convolutional neural network.

15. The Raman gain adaptive control system for multi-band optical network according to claim 13, further comprising:
combining the inverse model and the forward model to obtain a combined model, calculating the loss function based on the estimated gain values and an actual gain values, and training the combined model.

16. The Raman gain adaptive control system for multi-band optical network according to claim 11, wherein the step of calculating an objective function value based on the target gain values of the target channels and the gain values of the target channels screened out from the gain values of all the channels comprises:
calculating a root mean square error based on the target gain values of the target channels and the gain values of the target channels screened out from the gain values of all the channels; and
calculating the objective function value based on the root mean square error.

17. The Raman gain adaptive control system for multi-band optical network according to claim 16, wherein if a genetic algorithm is adopted, the objective function value is a fitness value, and the step of calculating the objective function value based on the root mean square error comprises: calculating the objective function value based on the following formula:
$$S = \frac{1}{R M S {E}_{{C}_{k n o w n}}} ;$$
wherein S is the calculated objective function value, RMSE_{C}_{_{known}} is the calculated root mean square error, and C_{known} represents the target channel.

18. The Raman gain adaptive control system for multi-band optical network according to claim 11, wherein the step of screening a final pump adjustment parameter from all the pump adjustment parameters after the last iteration is completed by adopting a first screening strategy or a second screening strategy, the first screening strategy comprising: a preset number of iterations are set, and one group of pump adjustment parameters are screened out as the final pump adjustment parameters when all the iterations are completed; and the second screening strategy comprising: determining the final pump adjustment parameters in an iteration process based on a preset screening threshold.

19. The Raman gain adaptive control system for multi-band optical network according to claim 18, wherein if a genetic algorithm is adopted, the objective function value is the fitness value, and the step of screening out one group of pump adjustment parameters as the final pump adjustment parameters comprises: taking the pump adjustment parameters corresponding to a highest fitness value as the final pump adjustment parameters.

20. The Raman gain adaptive control system for multi-band optical network according to claim 18, wherein if a genetic algorithm is adopted, the objective function value is the fitness value, and the step of determining the final pump adjustment parameters in an iteration process based on a preset screening threshold comprises: after each iteration is completed, comparing the calculated fitness value with the preset fitness threshold, and if the calculated fitness value is greater than the preset fitness threshold, taking this iteration as the last iteration, and outputting the pump adjustment parameters of this iteration as the final pump adjustment parameters.
